(19) United States
(12) Patent Application Publication
(10) Pub. No.: US 2014/0062097 A1
(43) Pub. Date: Mar. 6, 2014

(54) POWER GENERATION SYSTEM

(71) Applicants: Neil Brown, Holbeach (GB); Krzystof Paciura, Peterborough (GB)

(72) Inventors: Neil Brown, Holbeach (GB); Krzystof Paciura, Peterborough (GB)

(73) Assignee: CUMMINS GENERATOR TECHNOLOGIES LIMITED, Stamford, Lincolnshire (GB)

(21) Appl. No.: 14/110,501

(22) PCT Filed: Apr. 5, 2012
(86) PCT No.: PCT/GB12/00322

§ 371 Date: Nov. 19, 2013

(30) Foreign Application Priority Data
Apr. 8, 2011 (GB) 1106059.7

(51) Int. Cl. H02P 9/04

(52) U.S. Cl. CPC H02P 9/04
USPC 290/40 R

(57) ABSTRACT

A power generation system is disclosed for supplying power to an electrical grid. The system comprises an engine (1) and an electrical generator (3) coupled to the engine for generating an electrical output. Power electronics (6) are provided for converting the output of the electrical generator into an AC output at the operating frequency of the electrical grid. The engine is operated at a speed which is non-synchronous with the operating frequency of the electrical grid and at which the brake specific fuel consumption of the engine is minimised. The power electronics may also facilitate waste heat recovery and the connection of external energy sources.

The present invention relates to a power generation system, and in particular to a power generation system with an engine and a generator for supplying power to an electrical grid. The present invention is particularly concerned with improving the fuel efficiency of power generation, reducing emissions, and helping to ensure compliance with grid codes.

An electrical grid is an interconnected network for delivering electrical power from suppliers to consumers. Historically, electrical grids have consisted of high voltage transmission lines for transmitting electrical energy from large power plants to substations, and lower voltage distribution lines for distributing energy from the substations to consumers. However, electrical energy generation is becoming increasingly distributed, using a combination of alternative energy sources and fossil fuel based energy sources. Distributed generators tend to be relatively small units, often generating less than 5 or 10 MW, and may be located anywhere in the network.

Generator sets for electrical power generation include a prime mover, which is usually an engine, and an electrical machine that generates electrical power. The operating frequency of the generating set is linked to the mechanical speed of the engine, and thus it is necessary to operate the engine at a particular speed in order to produce an AC output of a particular frequency.

Various different mains power supply systems are in place around the world. The different systems are characterised by, amongst other things, their voltage and frequency. The two main standards are 230 V at 50 Hz and 120 V at 60 Hz. It is desirable for a generator set to be provided as a standard product for use with both 50 Hz and 60 Hz systems. However this requires the engine to operate at two different speeds. Typically the engine is operated at 1500 rpm to produce a 50 Hz output, and at 1800 rpm to produce a 60 Hz output. The need to operate the engine at two different speeds means that compromises have to be made in terms of engine efficiency. Alternatively, an additional gear box may be required to allow the engine to operate at a single speed for both a 50 Hz and 60 Hz output.

The power systems industry is facing challenges as more and more embedded generators such as wind turbines, solar panels, and combined heat and power plants are installed. Major incidents have already occurred where power systems have failed due to embedded generators disconnecting themselves during major frequency and voltage excursions on networks. The cause of the problem is that embedded generator protection tends to be set to disconnect the generating set if unusual events occur. One common example is when the sum of a network's generating plant cannot meet the demand. Under these circumstances the frequency of the power system tends to reduce. Often this reduced frequency causes the embedded generators to disconnect exasperating the problem further.

Grid operators define standards, called grid codes, which generators connected to the grid are required to comply with. Present grid codes are starting to specify more severe requirements such as wider voltage, frequency and power factor operating limits. In addition grid codes have started to specify “Low Voltage Ride Through”, where the generator needs to stay on line during fault conditions.

It is well known that internal combustion engines are not very fuel efficient. For example, a typical engine has an efficiency of around 40%, with most of the wasted energy being expelled as waste heat into the atmosphere. Techniques such as organic Rankine cycle and exhaust compounding exist which can capture some of the waste energy and convert it into useful energy.

A known system for connecting a generator set to a grid is disclosed in WO 2005/048433, the contents of which are incorporated herein by reference.

There remains a need for a power generation system with improved fuel efficiency, and with the flexibility to meet the demands of the grid.

According to a first aspect of the present invention there is provided a power generation system for supplying power to an electrical grid, the electrical grid having an operating frequency, the system comprising:
an engine;
an electrical generator coupled to the engine for generating an electrical output; and
conversion means for converting the output of the electrical generator into an AC output at the operating frequency of the electrical grid;
wherein the engine is operated at a speed which is non-synchronous with the operating frequency of the electrical grid and at which the brake specific fuel consumption of the engine is minimised.

By operating the engine at a speed which is non-synchronous with the operating frequency of the electrical grid and at which the brake specific fuel consumption of the engine is minimised, the engine can be tuned to improve the power and efficiency in comparison to the case where the engine is required to operate at a synchronous speed. Furthermore, speed regulation of the engine may be less critical, which may simplify the design of the engine control system.

The brake specific fuel consumption of the engine is preferably a measure of fuel efficiency, and is preferably equivalent to rate of fuel consumption divided by power produced. The point at which the brake specific fuel consumption of the engine is minimised is sometimes referred to as the engine “sweet spot”. This can be determined, for example, from a fuel map of the engine.

The engine may be tuned to have a maximum efficiency at a speed which is different from a speed corresponding to the operating frequency of the grid. This may allow the engine to be more efficient than if it was required to operate at synchronous speed.

In one embodiment, the engine is arranged to operate at a substantially constant speed. This may simplify the design of the engine and the engine control system. For example, it may be possible to dispense with an engine speed controller.

Alternatively, the engine may be operable at variable speed, for example where it is desired to compensate for the variation in power of other energy sources such as alternative energy sources.

Preferably the conversion means comprises power electronics. The use of power electronics can allow an AC output to be produced of a desired frequency and voltage, and can allow the engine and generator to be decoupled from the grid. The conversion means is preferably arranged to convert the frequency and/or voltage of the electrical generator into a different frequency and/or voltage. The AC output preferably has a substantially constant voltage and frequency suitable for supply to the electrical grid. The conversion means may comprise, for example, a rectifier, DC/DC converter and inverter, or a controllable rectifier and inverter, or an AC/AC converter.

In many circumstances it is desirable to produce a standard product which can be used with different mains standards. For example, it may be desirable to produce a power generation system which can produce either 120 V at 60 Hz or 230 V at 50 Hz, and/or some other combination of voltage and frequency. Thus the conversion means may be arranged to vary the frequency and/or voltage of the AC output.

The system may further comprise control means for controlling the conversion means to control the frequency and/or voltage of the AC output. For example, the control means may be arranged to select the frequency and/or voltage of the AC output. This can allow the power generation system to operate at two or more different frequencies and/or voltages, without the need to vary the operational speed of the engine. Thus the engine is able to operate at its most efficient speed for different frequency and voltage combinations.

The conversion means may comprise means (such as a rectifier) for converting the output of the generator to an intermediate DC output. The intermediate DC output may be regulated (for example, using a DC/DC converter) and may have a substantially constant voltage. An inverter may be used to convert the intermediate DC output to the AC output. This may provide a convenient and stable way of converting the output of the electrical generator into an AC output with a different frequency and/or voltage. Alternatively other conversions means, such as a cycloconverter, may be used.

The intermediate DC output may be supplied to a DC bus. This can provide a convenient way of connecting various different energy sources into the system, by allowing different energy sources to feed into the DC bus. The DC bus may be regulated, for example by using a DC/DC converter. The power generation system may further comprise an inverter for converting a voltage on the DC bus into an AC output for supply to the electrical grid. In this way some of the power electronics for different energy sources may be shared, which may reduce the cost of the system and increase the flexibility in meeting demand.

The system may further comprise means for receiving electrical power from a second energy source and for supplying the electrical power from the second energy source to the DC bus. The second source of energy may be internal (for example a battery or a waste energy recovery system) or external.

The second energy source may be a renewable energy source such as a wind turbine, wave turbine or solar cells. This arrangement can allow power to be supplied from renewable energy sources when available, while allowing this power to be supplemented with power from the generator set as needed.

The use of power electronics at the output of the generator also provides the opportunity to recover waste energy from the engine to improve efficiency further. Thus the second energy source may use waste energy recovery. For example, a turbine generator may be provided on the engine's exhaust system in order to recover energy and feed it to the DC bus. It may also be possible to recover some waste energy from the turbine generator. Alternatively or in addition a thermoelectric device may be provided for converting heat energy from the engine and/or other components into electrical power for supply to the DC bus.

A large part of the engine's waste energy is dissipated in the form of heat. In an embodiment of the invention, some of this waste heat is recovered and used as a second energy source. Thus the power generation system may further comprise:
a heat recovery unit for converting heat from the engine to mechanical energy;
a second electrical generator coupled to the heat recovery unit for generating electrical power from the mechanical energy of the heat recovery unit; and
means for converting an output of the second electrical generator to an intermediate DC output for supply to the DC bus.

By capturing the waste heat energy from the engine and combining this with the electrical energy from the generator, the overall fuel efficiency may be improved. Furthermore this arrangement can improve the flexibility of the system and help to ensure compliance with grid codes.

This aspect of the invention may also be provided independently, and thus, according to another aspect of the present invention there is provided a power generation system comprising:
an engine;
a main electrical generator coupled to the engine for generating electrical power;
means for converting an output of the main generator to an intermediate DC output;
a heat recovery unit for converting heat from the engine to mechanical energy;
a second electrical generator coupled to the heat recovery unit for generating electrical power from the mechanical energy of the heat recovery unit;
means for converting an output of the second generator to an intermediate DC output;
means for combining the intermediate DC output of the second generator with the intermediate DC output of the main generator; and
an inverter for converting the combined intermediate DC output into an AC output.

The heat recovery unit may be arranged to operate an organic Rankine cycle, or any other technique for waste heat recovery.

The power generation system may further comprise control means arranged to control the output of the second electrical generator so as to maintain the output of the system (for example, output voltage, frequency or power factor) within predetermined limits. For example, the control means may temporarily increase the proportion of power supplied from the second generator in the case of transient fault conditions or where the main generator is temporarily unable to meet all of the power demand. This may help to ensure a stable output and compliance with grid codes.

Grid codes are increasing specifying low voltage ride through as a requirement for generators connected to the grid. The use of power electronics at the output of the generator can help with low voltage ride through by decoupling the electrical system from the mechanical system. This can help prevent mechanical shocks from appearing on the generator set when the grid voltage reduces and then is restored.

The power generation system may further comprising means for detecting a fault on an electrical grid, means for disconnecting the system from the grid on detection of a fault, and control means arranged to keep the system connected to the grid during transient fault conditions. A transient fault may be, for example, a temporary reduction in or loss of grid voltage, and/or a deviation of the frequency from normally acceptable limits. Typically such faults are of relatively short duration (for example less than 500 mS). This can help to ensure compliance with grid codes. As an example, the control means may be arranged to provide low voltage ride through. For example, the control means may keep the power generation system online during a temporary low voltage event of, for example, less than 500 mS duration.

The use of power electronics at the output of the generator may also allow other parts of the power generating system to be simplified. For example, generator sets usually include circuit breakers on the output in order to protect the generator set in the event of a fault. However, the power electronics for producing the AC output may include switches. These switches may also be used instead of circuit breakers to isolate the generator set in the event of a fault. This can avoid the need to provide separate circuit breakers.

Thus the conversion means may include electrical switches for producing the AC output, and the electrical switches may be arranged to disconnect the system in the event of a fault.

In a conventional system with a synchronous generator connected to the grid, if a single phase or two-phase fault occurs, it is necessary to take the whole generator set offline. However, the use of power electronics at the output of the generator can allow the unaffected phase or phases to remain in operation. Thus, if a fault occurs on one phase, rather than blacking out the entire system, that one phase would go into a fault condition and the other two phases would remain online. Likewise, if a fault occurred on two phases, the system could still operate in a single phase mode of operation.

Therefore the system may be a multiphase system and may further comprise means for detecting a fault on each phase, and means for disconnecting a phase on which a fault is detected while the other phase or phases remain connected.

Conventional synchronous generators make use of a synchronizer in order to match the frequency and voltage of the generator those of the grid. However, in an embodiment of the invention, the synchronizing function is performed by the control electronics at the output of the generator. This is achieved by sensing the voltage and frequency on the grid, and adjusting the AC output accordingly. This can avoid the need for a separate synchronizer.

Thus the power generating system may further comprise means for sensing the frequency and/or voltage of the grid, and the conversion means may be arranged to adjust the frequency and/or voltage of the AC output to match the frequency and/or voltage of the grid. This may be achieved, for example, through use of the techniques disclosed in WO 2005/048433.

Electrical energy generation is becoming increasingly distributed, using a combination of alternative energy sources and fossil fuel based energy sources. As grids advance and grid operators start to communicate parameters (such as a set frequency) for distributed energy to operate at, the arrangements described above may provide some of the infrastructure for communication and control. Thus the system may be arranged to receive a command from a grid control centre specifying a parameter for the system, and to adjust the AC output in dependence thereon. The parameter may for, for example, one or more of frequency, voltage, power, power factor, or any other parameter. This can enable the system to work coherently within a wider imbedded power generation network.

For example, the system may be arranged to receive a command from a grid control centre specifying a voltage and/or frequency for the system, and to adjust the voltage and/or frequency of the AC output in dependence thereon.

The use of power electronics at the output of the generator allows additional flexibility in the amount of power factor correction that can be applied to the grid. For example, the power electronics may be able to provide anything from zero power factor lag to zero power factor lead capability, and this may be adjustable as required. This can help to stabilize the network and can enable network operators to manage the voltage on the grid better.

Thus the conversion means may be arranged to adjust the power factor of the AC output. For example, the system may further comprise means for sensing a power factor on the grid, and means for adjusting the power factor of the AC output in dependence thereon. Alternatively or in addition the system may be arranged to receive a command from a grid control centre specifying a power factor for the system, and to adjust the power factor of the AC output in dependence thereon.

In certain circumstances it may be desirable to adjust the output power of the power generation system. For example, in networks with alternative energy sources, it may be desirable to adjust the output of the power generating system in order to compensate for variations in the power of the alternative energy sources. Alternatively or in addition, a grid control centre may specify an output power for the system. Thus the system may further comprise means for adjusting the output power.

In an embodiment of the invention the speed of the engine is varied in dependence on the output power. For example, in the case of a wind turbine, being able to operate the engine at variable speed can allow the generator set to produce more power when there is a lack of wind, while operating more efficiently at a lower power when there is plenty of wind. Thus the system may further comprise control means for controlling the speed of the engine in dependence on the output power. This can allow the speed of the engine to be optimised for the output power, which may allow the fuel consumption of the engine to be improved.

The system may further comprise control means arranged to increase the proportion of the power supplied from a second energy source while the engine is accelerating. This can allow a certain amount of off-loading of the generator while the engine is accelerating, which can allow the engine to accelerate quickly to meet an increase in demand.

According to another aspect of the present invention there is provided a method of supplying power to an electrical grid, the electrical grid having an operating frequency, the method comprising:
driving an electrical generator with an engine to generate an electrical output;
converting the output of the electrical generator into an AC output at the operating frequency of the electrical grid; and
operating the engine at a speed which is non-synchronous with the operating frequency of the electrical grid and at which the brake specific fuel consumption of the engine is minimised.

According to another aspect of the invention there is provided a method of generating electrical power, the method comprising:
driving a main generator with an engine in order to produce electrical power;
converting an output of the main generator to an intermediate DC output;
converting heat from the engine to mechanical energy;
driving a second electrical generator with the mechanical energy in order to produce electrical power;
converting an output of the second generator to an intermediate DC output;
combining the electrical power produced by the main electrical generator with the electrical power produced by the second electrical generator to produce an electrical output; and
converting the combined intermediate DC output into an AC output.

According to another aspect of the present invention there is provided a power generation system comprising:
an engine;
a main electrical generator coupled to the engine for generating electrical power;
a heat recovery unit for converting heat from the engine to mechanical energy;
a second electrical generator coupled to the heat recovery unit for generating electrical power from the mechanical energy of the heat recovery unit; and
means for combining the electrical power produced by the main electrical generator with the electrical power produced by the second electrical generator to produce an electrical output.

According to another aspect of the present invention there is provided a power generation system comprising:
an engine;
a main electrical generator coupled to the engine which generates electrical power;
a heat recovery unit which converts heat from the engine to mechanical energy;
a second electrical generator coupled to the heat recovery unit which generates electrical power from the mechanical energy of the heat recovery unit; and
a combining unit which combines the electrical power produced by the main electrical generator with the electrical power produced by the second electrical generator to produce an electrical output.

Features of one aspect of the invention may be provided with any other aspect. Apparatus features may be provided with method aspects and vice versa.

Preferred features of the present invention will now be described, purely by way of example, with reference to the accompanying drawings, in which:

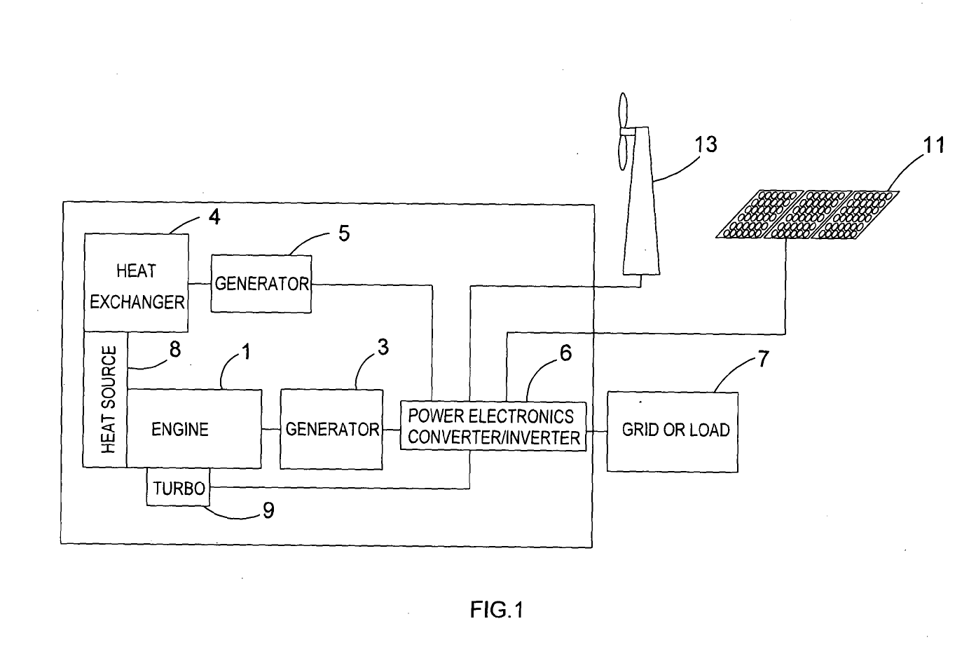

FIG. 1 shows an overview of a power generation system according to an embodiment of the present invention;

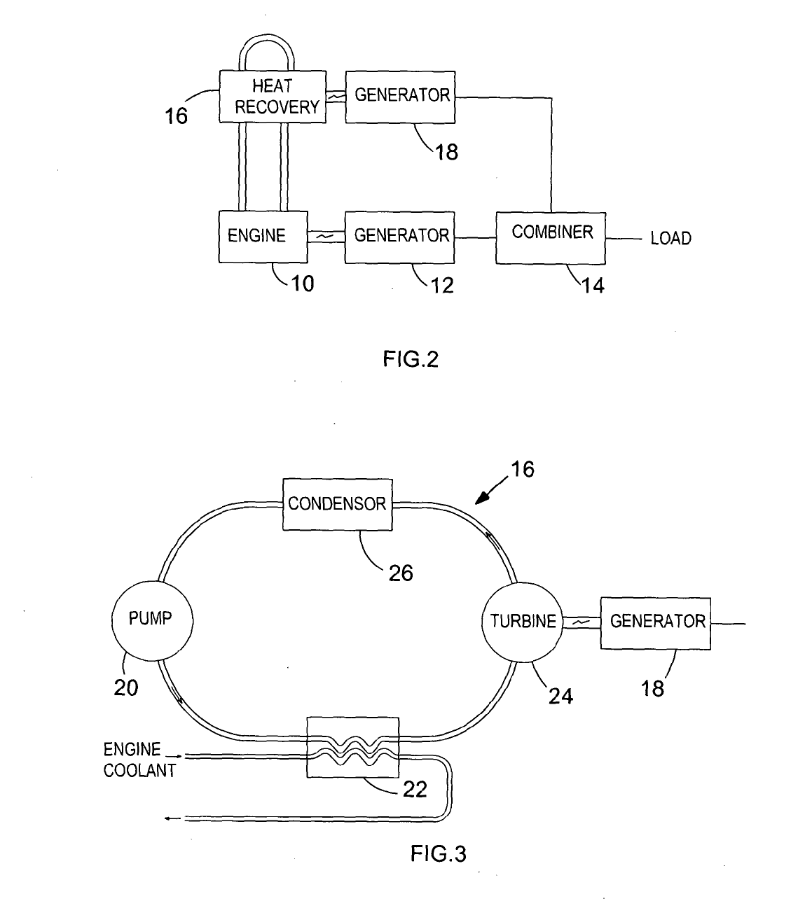

FIG. 2 shows an overview of a waste heat energy recovery system;

FIG. 3 shows an overview of a heat recovery unit;

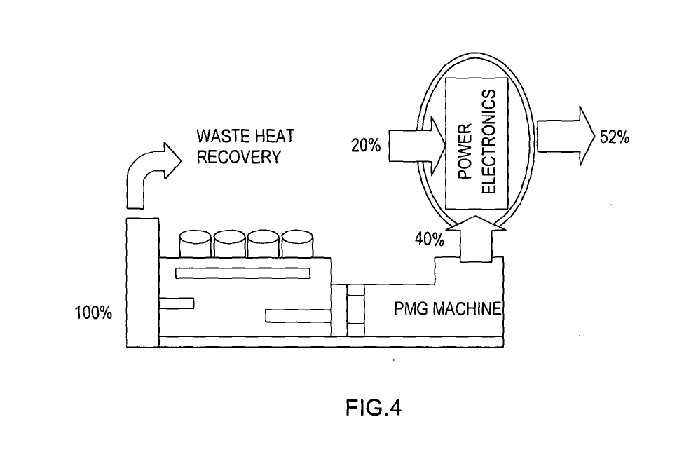

FIG. 4 shows schematically how the fuel efficiency of a power generation system can be improved;

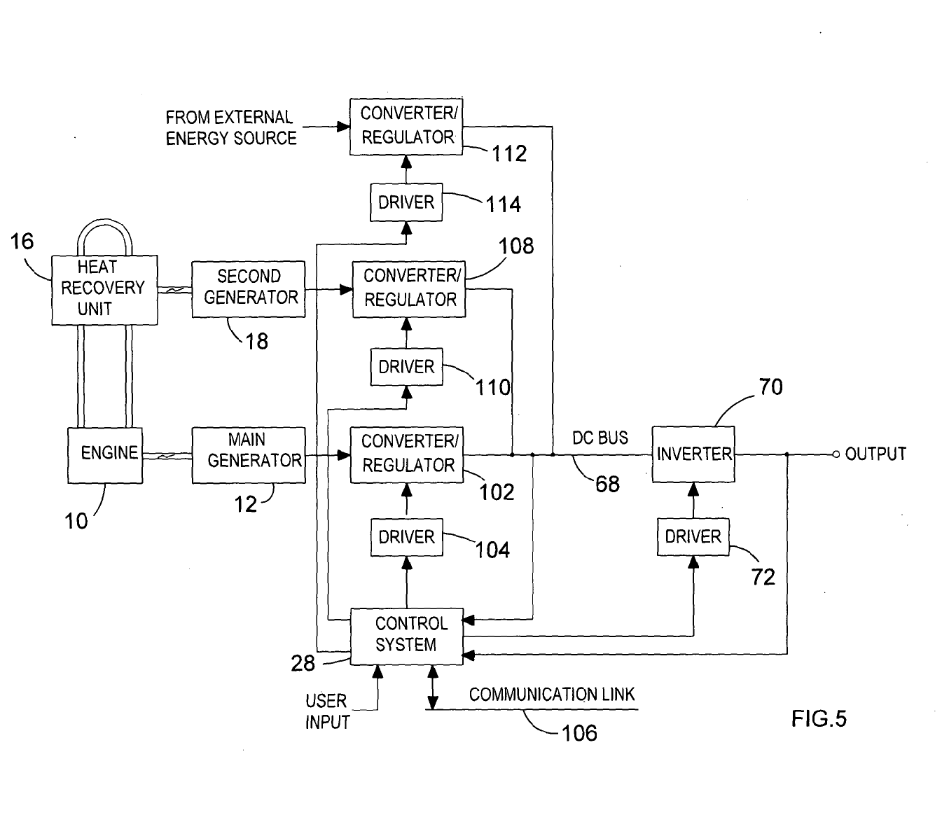

FIG. 5 shows an embodiment of a continuous speed power generation system;

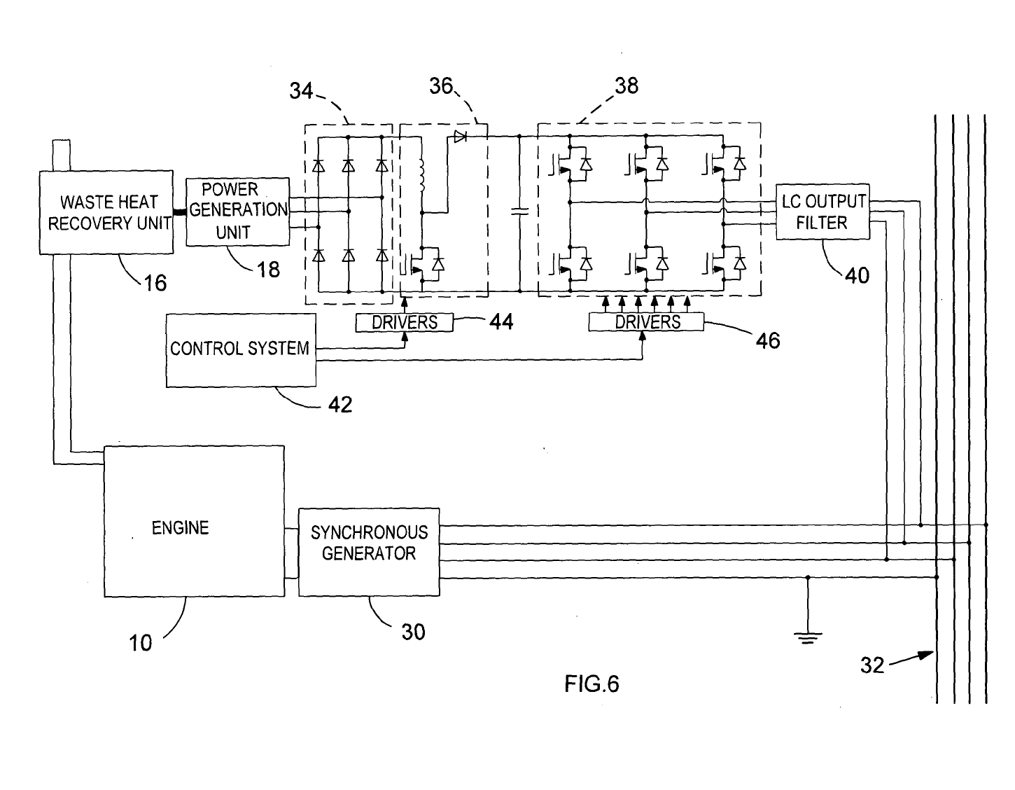

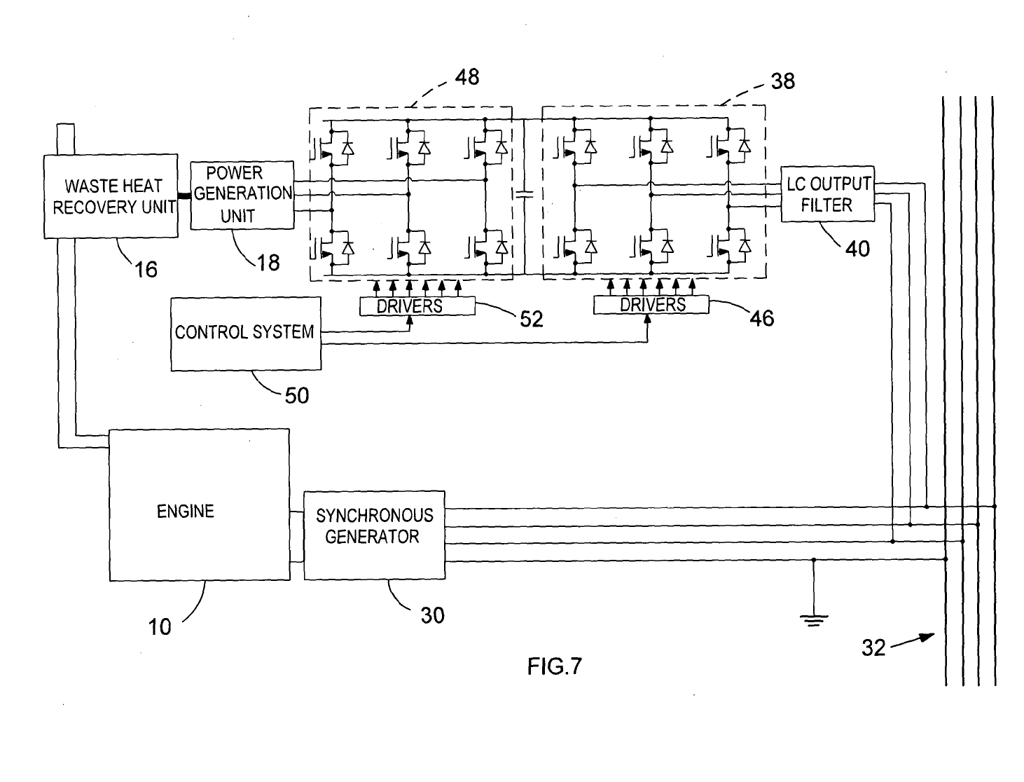

FIGS. 6 and 7 show examples of a power generation system with a synchronous generator;

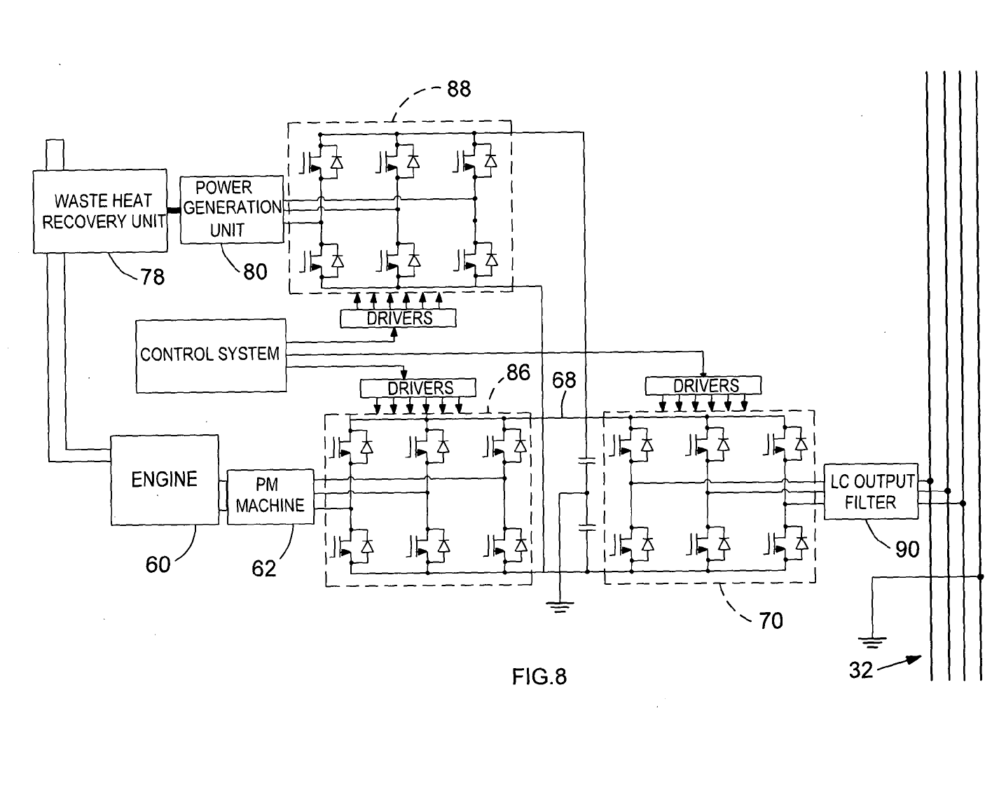

FIGS. 8 to 10 show examples of a power generation system in which the generator is decoupled from the electrical output; and

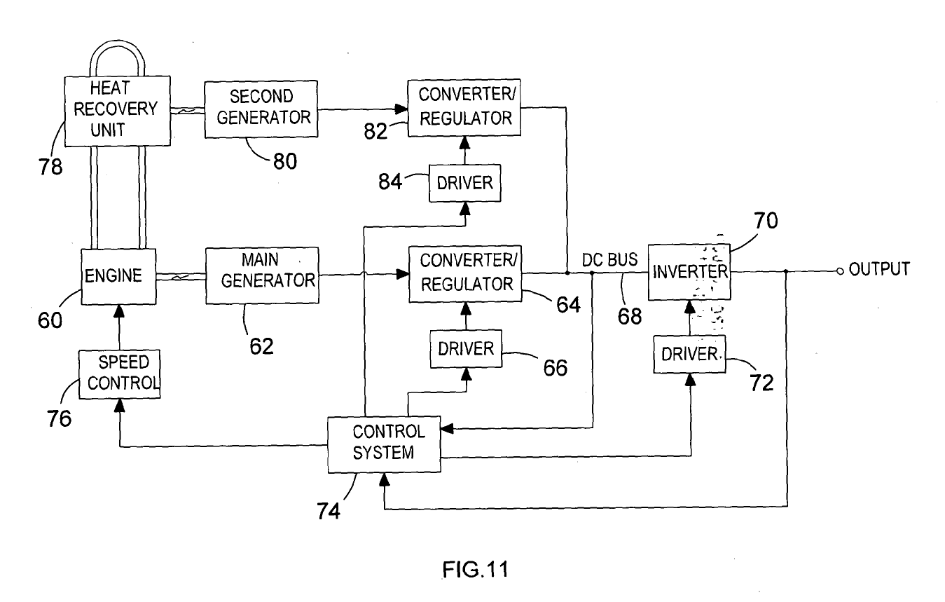

FIG. 11 shows an embodiment of a variable speed power generation system.

FIG. 1 shows an overview of a power generation system in an embodiment of the present invention. Referring to FIG. 1, the system comprises engine 1, generator 3 and power electronics 6. The engine 1 is mechanically coupled to the generator 3. In operation, the engine 1 drives the generator 3, which causes the generator 3 to produce an electrical output. The electrical output of the generator 3 is fed to power electronics 6, which convert the output of the generator into a voltage and frequency suitable for connection to the load 7, which may be an electrical grid.

In the arrangement of FIG. 1, the engine 1 and generator 3 are decoupled from the load 7 by means of the power electronics 6. Thus it is not necessary for the engine to be run at synchronous speed. This can allow the engine to operated at its “sweet spot”, which is the point at which the engine returns maximum power for fuel consumed. The location of the sweet spot can be determined from the engine's fuel map. The engine can be tuned to improve the power and the efficiency in comparison to the case where it is required to operate at a particular speed.

Since the engine does not need to run at a particular speed, speed regulation is not so critical. It may therefore be possible to remove some components which would be used for speed regulation. Furthermore, the power electronics are able to modify the frequency and voltage of the AC output, rather than requiring the operational speed of the engine to be adjusted. This can allow a standard product to be provided for different markets with different voltage and frequency systems.

In the arrangement shown in FIG. 1, renewable energy sources such as solar panels 11 and wind turbine 13 are available. The power electronics 6 are arranged to convert the (typically) variable voltage, variable frequency outputs of the renewable energy sources 11, 13 into a voltage and frequency suitable for connection to the load 7.

Also shown in FIG. 1 are heat source 8, heat exchanger 4, and second electrical generator 5. The heat source 8 and heat exchanger 4 are arranged to recover waste heat from the engine 1, and convert this waste heat to rotary motion. The mechanical output of the heat exchanger 4 is used to drive the second generator 5. The electrical output of second generator 5 is fed to the power electronics 6. The power electronics convert the voltage and frequency of the second generator 5 into a voltage and frequency suitable for connection to the load 7.

In the arrangement of FIG. 1, a turbine generator (turbo) 9 is connected to the engine 1. The turbo 9 is used to recover waste energy from the engine's exhaust. This is converted to electrical energy and fed to the power electronics 6.

FIG. 2 shows an overview of a heat energy recovery system in an embodiment of the invention. Referring to FIG. 2, the system comprises engine 10, main generator 12, combiner 14, heat recovery unit 16, and second generator 18. In the arrangement of FIG. 2, the heat recovery unit 16 is arranged to recover waste heat from the engine 10, and convert this waste heat to rotary motion. The mechanical output of the heat recovery unit 16 is used to drive second generator 18. The electrical output of second generator 18 is fed to combiner 14, where it is combined with the electrical output of the main generator 12, in order to contribute to the electrical power supplied to the load. The combiner 14 includes power electronics in order to convert the voltage and frequency of the second generator 18 and/or the main generator 12 to desired levels, in order to enable the two outputs to be combined.

FIG. 3 shows an overview of heat recovery unit 16. In this embodiment, the heat recovery unit 16 uses the organic Rankine cycle to produce mechanical energy from the waste heat of the engine 10. The organic Rankine cycle uses an organic working fluid with a lower boiling point than that of water, which allows heat recovery from lower temperature sources.

Referring to FIG. 3, the heat recovery unit comprises circulating pump 20, evaporator 22, turbine 24 and condenser 26. In operation, the circulating pump 20 pumps an organic working fluid through the system. The working fluid enters the evaporator 22 as a liquid. In the evaporator, the working fluid undergoes a phase change from a liquid to a pressurised gas. The evaporator receives its heat input from the waste heat of the engine 10. For example, the evaporator may include a heat exchanger which receives the engine's heated coolant and transfers the heat to the heat recovery unit's working fluid. The gaseous phase working fluid exits the evaporator and enters the turbine 24. In the turbine the pressurised gas expands, which causes mechanic energy to be produced. A low pressure gas exits the turbine, and is returned to liquid phase by the condenser 26. The mechanical output of the turbine 24 is used to drive the second electrical generator 18.

FIG. 4 shows schematically how the present invention can improve the fuel efficiency of the power generation system. The schematic shows 100% of the energy in fuel. Typically an engine and generator are only around 40% efficient, with most of the remaining energy being lost as waste heat. It has been found that around 20% of the waste energy can be recovered using a waste heat recovery unit. Both sources of electrical energy are supplied to the power electronics. This can allow the overall efficiency of the power generation system to be increased from 40% to 52%.

By capturing the waste heat energy from the engine and combining this with the electrical energy from the generator a number of advantages are possible. In particular, much less fuel will be consumed, the power density of the set can be improved, and the power electronics can provide the flexibility required from the grid. For example, the auxiliary power from the second generator can assist the main generator in meeting voltage, frequency and power factor operating limits required by the grid.

FIG. 5 shows an embodiment of a power generation system in which the engine is operated continuously at a speed at which it returns maximum power for fuel consumed. In this embodiment speed regulation is not critical and so it may be possible to remove some components which would otherwise be used for speed regulation.

Referring to FIG. 5, the system comprises engine 10, main generator 12, first converter/regulator 102, first driver 104, DC bus 68, inverter 70, inverter driver 72, control system 28, communication link 106, heat recovery unit 16, second generator 18, second converter/regulator 108, second driver 110, third converter/regulator 112, and third driver 114. In operation, the engine 10 drives the main generator 12, which causes the generator to generate an electrical output. The output of main generator 12 is fed to converter/regulator 102. The converter/regulator 102 converts the output of the generator 12 to a regulated DC voltage for supply to DC bus 68. The heat recovery unit 16 recovers waste heat from the engine 10, and converts this waste heat to rotary motion. The mechanical output of the heat recovery unit 16 is used to drive second generator 18.

The electrical output of second generator 18 is fed to second converter/regulator 108. The second converter/regulator 108 converts the variable voltage, variable frequency output of the second generator 18 to a regulated DC voltage for supply to DC bus 68. The output from an external energy source, such as a wind or wave turbine or solar cell bank, is fed to third converter/regulator 112. The third converter/regulator 112 converts the (typically) variable voltage, variable frequency output of the external energy source to a regulated DC voltage for supply to DC bus 68. The inverter 70 converts the regulated DC voltage on the DC bus 68 to an AC output of the required voltage and frequency.

In the arrangement of FIG. 5, the control system 28 senses the voltage and/or current of the DC bus 68, and controls the drivers 104, 110 and 114 so as to regulate the voltage on the DC bus. For example, the converter/regulators 102, 108 and 112 may each comprise a rectifier and a DC/DC converter, and the control system 28 and drivers 104, 110 and 114 may control the operation of the DC/DC converters. Alternatively the converter/regulators may comprise controllable rectifiers. The control system 28 also senses the voltage and/or current at the output of the inverter 70, and controls the inverter driver 72 so as to produce an AC output of the desired voltage and frequency.

In the arrangement of FIG. 5, the control system 28 can receive commands from a grid control centre via communication link 106. The control system 28 may adjust the AC output in dependence on the received commands. For example, the control system may receive a command specifying a required output frequency, voltage, power or power factor, and may control the driver 72 and inverter 70 to produce the required output. This can enable the system to work coherently within a wider embedded power generation network.

The control system 28 can also receive a signal from the user, and adjust output parameters such as frequency and/or voltage in dependence thereon. This can allow the user to select an appropriate frequency and voltage at the output.

FIG. 6 shows one example of a power generation system. In FIG. 6, engine 10 is mechanically coupled to a synchronous generator 30. In this embodiment the engine 10 is operated at a constant speed, and the synchronous generator produces a three phase output of constant voltage and frequency for supply to electrical grid 32. Waste heat from the engine 10 is supplied to heat recovery unit 16. The heat recovery unit 16 converts the waste heat to mechanical energy which is used to drive second generator 18. Since the amount of energy that can be recovered from the waste heat is likely to vary over time, the generator 18 is adapted to operate at variable speed. For example, the generator 18 may be a permanent magnet generator, or a synchronous generator adapted to run at variable speed.

In the arrangement of FIG. 6, the output of the second generator 18 is connected to power electronics consisting of rectifier 34, DC/DC converter 36, inverter 38 and output filter 40. Control system 42, converter driver 44 and inverter driver 46 are used to control the DC/DC converter 36 and inverter 38. In operation the rectifier 34 converts the variable AC output of the generator to a variable DC output. The DC/DC converter 36 in combination with control system 42 and driver 44 regulates the output of the rectifier to produce a DC output with a substantially constant voltage. The inverter 38 in combination with control system 42 and driver 46 converts the regulated DC output of the DC/DC converter into a three-phase AC output with the same voltage and frequency as the output of the synchronous generator 30. The output of the inverter 38 is filtered by output filter 40, and then combined with the output of synchronous generator 30. The combined output is supplied to electrical grid 32.

FIG. 7 shows another example of a power generation system. In the example of FIG. 7, the rectifier 34 and DC/DC converter 36 of FIG. 6 are replaced by controllable rectifier 48. The example of FIG. 7 operates in a similar way to that of FIG. 6. However, the controllable rectifier 48 is used to rectify and regulate the output of the generator 18. The controllable rectifier 48 is controlled by control system 50 and drivers 52. The other components of FIG. 7 function in a similar way to those of FIG. 6, and are given the same reference numerals.

FIG. 8 shows an another example of a power generation system. In FIG. 8, a controllable rectifier 86 is used to rectify and regulate the output of the main generator 62, and a controllable rectifier 88 is used to rectify and regulate the output of the second generator 80. The regulated outputs are fed to DC bus 68. Inverter 70 converts the voltage on the DC bus 68 to an AC output of the required voltage and frequency. The output is filtered by filter 90 and fed to electrical grid 32.

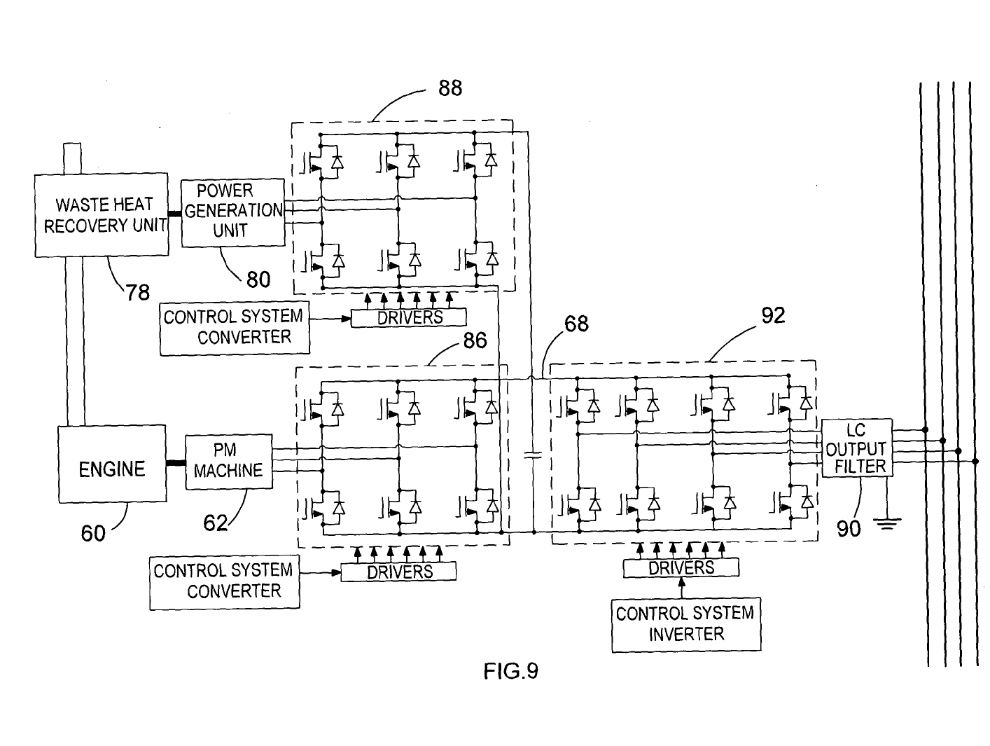

FIG. 9 shows another example of a variable speed power generation system. The arrangement of FIG. 8 functions in a similar way to that of FIG. 8. However in FIG. 9 an inverter with a three phase output and a ground is used.

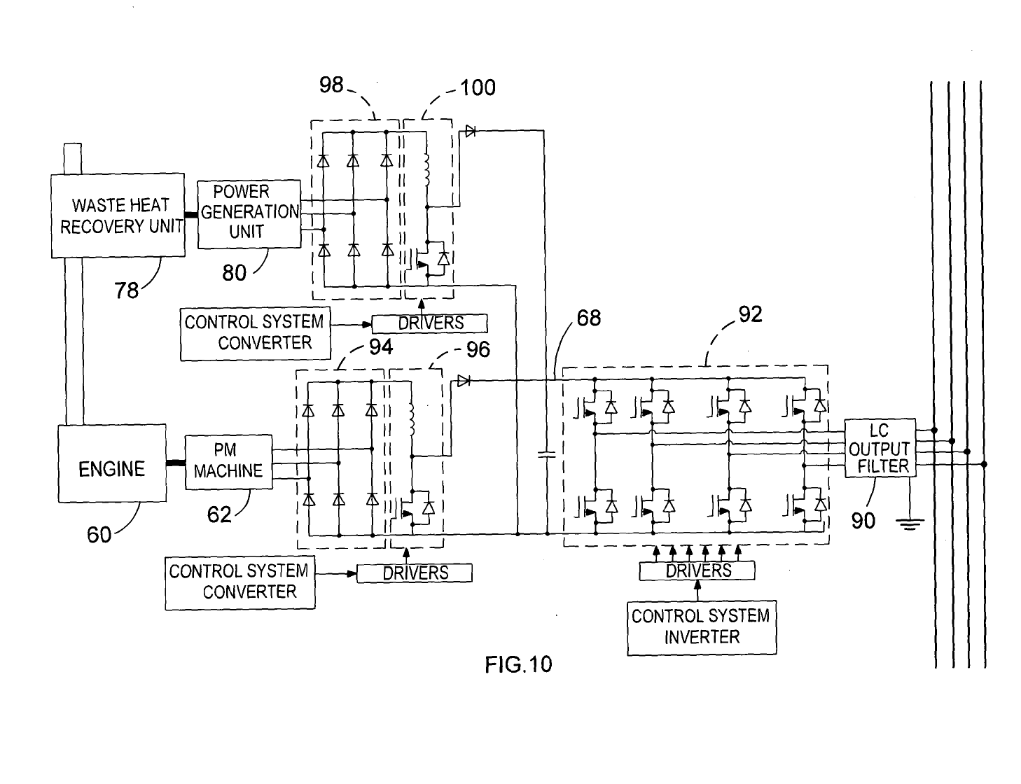

FIG. 10 shows another example of a variable speed power generation system. The arrangement of FIG. 10 functions in a similar way to that of FIGS. 8 and 9. In the arrangement of FIG. 10, a rectifier 94 and DC/DC converter 96 are provided at the output of main generator, and a rectifier 98 and DC/DC converter 100 are provided at the output of second generator 80. The rectifier 94 converts the AC output of the main generator 62 to a variable voltage DC output. The DC/DC converter 96 regulates the output of the rectifier to produce a DC output with a substantially constant voltage. The rectifier 98 converts the AC output of the second generator 80 to a variable voltage DC output. The DC/DC converter 100 regulates the output of the rectifier to produce a DC output with a substantially constant voltage. The regulated voltages are fed to DC bus 68.

The embodiments of FIGS. 8 to 10 can allow the engine to operate at its sweet spot, which is the point at which the engine returns maximum power for fuel consumed. Furthermore, due to the presence of a second source of electrical energy, the system may be able to tolerate wider voltage, frequency and power factor operating limits before protection circuits disconnect the generators. For example, the second generator may help the system to stay on-line during temporary low-voltage events (low voltage ride-through). This can help the system to comply with grid codes specified by the grid operator.

FIG. 11 shows an embodiment of a power generation system in which the engine is operated at variable speed. Referring to FIG. 11, the system comprises variable speed engine 60, main generator 62, converter/regulator 64, driver 66, DC bus 68, inverter 70, inverter driver 72, control system 74, speed control unit 76, heat recovery unit 78, second generator 80, converter/regulator 82, and driver 84.

In operation, the variable speed engine 60 drives the main generator 62, which causes the generator to produce a variable voltage, variable frequency electrical output. The output of main generator 62 is fed to converter/regulator 64. The converter/regulator 64 converts the variable voltage, variable frequency output of the generator 62 to a regulated DC voltage for supply to DC bus 68. The heat recovery unit 78 recovers waste heat from the engine 60, and converts this waste heat to rotary motion. The mechanical output of the heat recovery unit 78 is used to drive second generator 80. The electrical output of second generator 80 is fed to converter/regulator 82. The converter/regulator 82 converts the variable voltage, variable frequency output of the second generator 80 to a regulated DC voltage for supply to DC bus 68. The inverter 70 converts the regulated DC voltage on the DC bus 68 to an AC output of the required voltage and frequency.

In FIG. 11, the control system 74 senses the voltage and/or current of the DC bus 68, and controls the drivers 66 and 84 so as to regulate the voltage on the DC bus. For example, the converter/regulators 64, 82 may each comprise a rectifier and a DC/DC converter and the control system 74 and drivers 66 and 84 may control the operation of the DC/DC converters. Alternatively the converter/regulators may comprise controllable rectifiers. The control system 74 also senses the voltage and/or current at the output of the inverter 70, and controls the inverter driver 72 so as to produce an AC output of the desired voltage and frequency.

In the arrangement of FIG. 11, the control system 74 senses the power at the output of the inverter 70 and/or the DC bus 68, and produces a speed control signal in dependence on the sensed power. The speed control signal is fed to speed control unit 76, which adjusts the speed of the engine accordingly. This can allow the speed of the engine to be controlled so that the engine operates at optimum efficiency for the demanded power. The main generator 62 can be a permanent magnet generator, or a synchronous generator adapted for variable speed operation.

The arrangement of FIG. 11 can also help the power generation system to comply with grid codes specified by the grid operator. For example, if there is an increase in the power demand so that the engine needs to accelerate, then the main generator may temporarily be unable to meet all of the demanded power. In these circumstances the voltage of the DC bus would normally drop, resulting in a reduced voltage at the AC output. However, in the arrangement of FIG. 11, the control system may be able to temporarily increase the proportion of the power supplied from the second generator, due to the stored energy in the heat recovery unit and the second generator. In this case the converter/regulator at the output of the second generator may be able to maintain the DC bus at the required voltage, thereby helping to maintain the output voltage while the engine accelerates.

The embodiments described above allow the recovery of energy in the form of heat from a combustion engine which would be otherwise wasted. Recovered heat is transferred to a heat exchanger and then converted to rotary motion which drives a second generator. The electrical energy from the second generator is then converted inside a power electronics module to the desire level for combination with the output of the main generator. This can allow significant savings in fuel consumption to be achieved.

Other potential advantages of the present invention are as follows.

The power electronics converters can allow new control strategies. Permanent magnet generators can be use instead of synchronous generators, resulting in size reduction of the electrical machine. The power electronics can give more flexibility as far as the electrical machine speed is concerned, which can lead to more efficient ways of recovering wasted energy. Although the power electronics unit is an additional cost to the system initially, in terms of life cycle cost, the power electronics allows considerable savings to be achieved.

The power electronics can allow new approaches to wasted heat recovery (e.g. variable speed application). The power electronics can be used in different configurations as an auxiliary system or as a primary system. The power generation system can be used as an auxiliary source of power whenever other external or internal sources of electrical energy are available (e.g. wind energy, solar energy, energy recover from turbo systems).

The engine can operate at a speed that provides the desired compromise between power density and efficiency. This could be a continuous power mode. The engine could be operated at variable speed for variable power requirements to ensure minimum fuel consumption. The power electronics may allow the system to be standardised, reducing the need to design different generating sets for different voltages and frequencies of operation. It may also be possible to simplify the electrical machine, as it may no longer be required to be connected directly to the grid.

It will be understood that various embodiments of the present invention have been described above purely by way of example, and modifications of detail can be made within the scope of the invention. In some of the drawings, parts of the overall system have been omitted for clarity. Features described in relation to one embodiment may be provided with any of the other embodiments.

1-37. (canceled)

38. A power generation system comprising:
an engine;
a main electrical generator coupled to the engine for generating electrical power;
a first converter for converting an output of the main generator to an intermediate DC output;
a heat recovery unit for converting heat from the engine to mechanical energy;
a second electrical generator coupled to the heat recovery unit for generating electrical power from the mechanical energy of the heat recovery unit;
a second converter for converting an output of the second generator to an intermediate DC output;
a combiner for combining the intermediate DC output of the second generator with the intermediate DC output of the main generator; and
an inverter for converting the combined intermediate DC output into an AC output.

39. A power generation system according to claim 38, wherein the heat recovery unit is arranged to operate an organic Rankine cycle.

40. A power generation system according to claim 38, further comprising a controller arranged to control the output of the second electrical generator so as to maintain the output of the system within predetermined limits.

41. A power generation system according to claim 40, wherein the controller is arranged to increase temporarily the proportion of power supplied from the second generator in the case of transient fault conditions or where the main generator is temporarily unable to meet all of the power demand.

42. A power generation system according to claim 38, further comprising:
a fault detector for detecting a fault on an electrical grid;
means for disconnecting the system from the grid on detection of a fault; and
a controller means arranged to keep the system connected to the grid during transient fault conditions.

43. A system according to claim 42, wherein the controller is arranged to provide low voltage ride through.

44. A power generation system according to claim 38, wherein the inverter includes electrical switches for producing the AC output, and the electrical switches are arranged to disconnect the system in the event of a fault.

45. A power generation system according to claim 38, wherein the system is a multiphase system and further comprises:
a fault detector for detecting a fault on each phase; and
means for disconnecting a phase on which a fault is detected while the other phase or phases remain connected.

46. A power generation system according to claim 38 for connection to an electrical grid, further comprising a sensor for sensing the frequency and/or voltage of the grid, wherein the system is arranged to adjust the frequency and/or voltage of the AC output to match the frequency and/or voltage of the grid.

47. A power generation system according to claim 38, wherein the system is arranged to receive a command from a grid control centre specifying a parameter for the system, and to adjust the AC output in dependence thereon.

48. A power generation system according to claim 38, wherein the system is arranged to receive a command from a grid control centre specifying a voltage and/or frequency for the system, and to adjust the voltage and/or frequency of the AC output in dependence thereon.

49. A power generation system according to claim 38, wherein the system is arranged to adjust the power factor of the AC output.

50. A power generation system according to claim 49, wherein the system is arranged to receive a command from a grid control centre specifying a power factor for the system, and to adjust the power factor of the AC output in dependence thereon.

51. A power generation system according to claim 38, further comprising a controller for adjusting the output power.

52. A power generation system according to claim 38, further comprising a controller for controlling the speed of the engine in dependence on the output power.

53. A power generation system according to claim 38, further comprising a controller arranged to increase a proportion of power supplied from a second energy source while the engine is accelerating.

54. A power generation system according to claim 38, wherein:
the system is arranged to supply power to an electrical grid, the electrical grid having an operating frequency; and
the engine is operated at a speed which is non-synchronous with the operating frequency of the electrical grid.

55. A power generation system according to claim 54, wherein the engine is operated at a speed at which the brake specific fuel consumption of the engine is minimised.

56. A power generation system according to claim 54, wherein the engine is tuned to have a maximum efficiency at a speed which is different from a speed corresponding to the operating frequency of the grid.

57. A power generation system according to claim 54, wherein the engine is arranged to operate at a substantially constant speed.

58. A power generation system according to claim 38, wherein the converters comprise power electronics.

59. A power generation system according to claim 38, wherein the inverter is arranged to convert the frequency and/or voltage of the electrical generator into a different frequency and/or voltage.

60. A power generation system according to claim 38, wherein the inverter is arranged to vary the frequency and/or voltage of the AC output.

61. A power generation system according to claim 38, further comprising a controller for controlling the inverter to control the frequency and/or voltage of the AC output.

62. A power generation system according to claim 61, wherein the controller is arranged to select the frequency and/or voltage of the AC output.

63. A power generation system according to claim 38, wherein the power generation system is operable at two or more different frequencies and/or voltages

64. A power generation system according to claim 38, wherein the intermediate DC output is regulated and has a substantially constant voltage.

65. A power generation system according to claim 38, wherein the intermediate DC output is supplied to a DC bus.

66. A power generation system according to claim 65, further comprising means for receiving electrical power from a second energy source and for supplying the electrical power from the second energy source to the DC bus.

67. A power generation system according to claim 65, further comprising a thermoelectric device for converting heat energy from the engine into electrical power for supply to the DC bus.

68. A power generation system arranged to supply power to an electrical grid, the electrical grid having an operating frequency, the system comprising:
an engine;
an electrical generator coupled to the engine for generating an electrical output; and
a converter for converting the output of the electrical generator into an AC output at the operating frequency of the electrical grid;
wherein the engine is operated at a speed which is non-synchronous with the operating frequency of the electrical grid and at which the brake specific fuel consumption of the engine is minimised.

69. A power generation system according to claim 68, wherein the engine is tuned to have a maximum efficiency at a speed which is different from a speed corresponding to the operating frequency of the grid.

70. A power generation system according to claim 69, wherein the engine is arranged to operate at a substantially constant speed.

71. A method of generating electrical power, the method comprising:
driving a main generator with an engine in order to produce electrical power;
converting an output of the main generator to an intermediate DC output;
converting heat from the engine to mechanical energy;
driving a second electrical generator with the mechanical energy in order to produce electrical power;
converting an output of the second generator to an intermediate DC output;
combining the electrical power produced by the main electrical generator with the electrical power produced by the second electrical generator to produce an electrical output; and
converting the combined intermediate DC output into an AC output.
